(19) United States
(12) Patent Application Publication
(10) Pub. No.: US 2011/0139539 A1
(43) Pub. Date: Jun. 16, 2011

(54) STRUCTURE FOR REDUCING ACOUSTIC LOAD

(75) Inventor: Jang-Sup CHOI, Daejeon (KR)

(73) Assignee: ELECTRONICS AND TELECOMMUNICATIONS RESEARCH INSTITUTE, Daejeon (KR)

(21) Appl. No.: 12/829,795

(22) Filed: Jul. 2, 2010

(30) Foreign Application Priority Data
Dec. 15, 2009 (KR) 10-2009-0124853

(51) Int. Cl. F16F 15/04

(52) U.S. Cl. 181/207

(57) ABSTRACT

Provided is a structure for reducing an acoustic load. The structure includes a tape structure. The tape structure includes an attachment part configured to be attached to a substrate, and an off-position part spaced apart from the substrate and having at least one ventilation hole. Therefore, owing to the resilience of the attachment part and shock-absorbing ability of an air layer formed between the off-position part and the substrate, an acoustic load can be reduced. In addition, since air can flow through the ventilation hole, the attachment part of the tape structure may be not separated by variations of air pressure.

### CROSS-REFERENCE TO RELATED APPLICATIONS

This U.S. non-provisional patent application claims priority under 35 U.S.C. §119 of Korean Patent Application No. 10-2009-0124853, filed on Dec. 15, 2009, the entire contents of which are hereby incorporated by reference.

### BACKGROUND OF THE INVENTION

The present invention disclosed herein relates to a structure for reducing an acoustic load.

When a satellite mounted on a projectile is launched, an acoustic noise load may be on a propulsion system of the projectile. Such an acoustic noise load varies according to the kind and size of projectiles, and due to the characteristics of acoustic noise load, thin-film structures such as solar panels or antennas are significantly affected by the acoustic noise load. Therefore, generally, space structures are designed to endure noises of 145.5 dB or higher and are tested in an acoustic chamber before launch for ensure safety. To meet these requirements, space structures should be manufactured with sufficient design margins from acoustic noise load conditions; however, this may increase the weights and manufacturing costs of the space structures. Moreover, since installation or attachment of additional devices is necessary to block acoustic noise to a certain degree, complex systems and additional processes may be required, and by this, the weights or volumes of space structures will be increased to decrease the efficiency of the space structures. In addition, materials for such additional devices should fulfill various space material requirements. For example, such materials should be stable without significant property changes under extreme conditions such as wide-range temperature variations, high-degree vacuum environments, solar radiations, and space radiations, and outgassing of the materials should not exceed allowed levels for space materials.

### SUMMARY OF THE INVENTION

The present invention provides a structure for reducing an acoustic load so as to prevent a thin-film structure sensitive to an acoustic load from being damaged or broken by an acoustic load.

Embodiments of the present invention provide structures for reducing an acoustic load, the structures including: a substrate; and a tape structure disposed at a side of the substrate, wherein the tape structure includes: an attachment part configured to be attached to the substrate; and an off-position part spaced apart from the substrate and including at least one ventilation hole.

In some embodiments, the attachment part may have a closed loop shape, and an air layer may be formed between the off-position part and the substrate.

In other embodiments, the tape structure may include a Kapton tape.

In still other embodiments, the tape structure may be repeatedly attached to the side of the substrate in the same pattern.

In even other embodiments, the substrate may be a thin-film structure substrate.

In yet other embodiments, the thin-film structure substrate may be a satellite solar panel or a satellite antenna.

In further embodiments, the off-position part may include a polyamide film having a multi-layer structure.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a plan view illustrating a structure for reducing an acoustic load according to an embodiment of the present invention;

FIG. 2 is a sectional view taken along line I-II of FIG. 1;

FIG. 3 is a view illustrating exemplary sensor arrangement on the acoustic load reducing structure in an experiment performed according to the present invention; and

FIG. 4 is an image illustrating the acoustic load reducing structure in the experiment performed according to the present invention.

### DETAILED DESCRIPTION OF PREFERRED EMBODIMENTS

The present invention and implementation methods thereof will be clarified through following embodiments described with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Further, the present invention is only defined by scopes of claims. Like reference numerals refer to like elements throughout the specification.

Hereinafter, it will be described about an exemplary embodiment of the present invention in conjunction with the accompanying drawings.

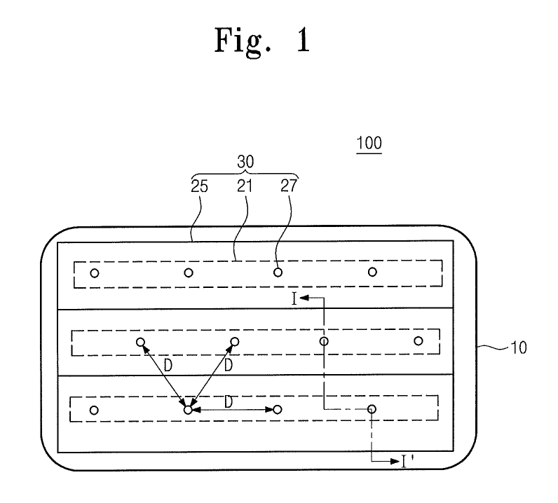

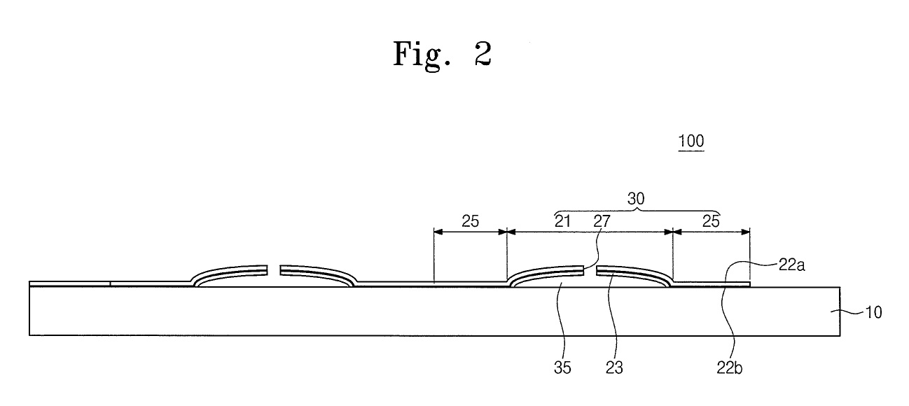

FIG. 1 is a plan view illustrating a structure 100 for reducing an acoustic load according to an embodiment of the present invention, and FIG. 2 is a sectional view taken along line I-II of FIG. 1.

Referring to FIGS. 1 and 2, according to the current embodiment, the acoustic load reducing structure 100 includes a substrate 10 and a tape structure 30 attached to a side of the substrate 10. The substrate 10 may have a thin-film structure. For example, the substrate 10 may be a satellite solar panel or antenna. If the substrate 10 is a satellite panel or antenna, the tape structure 30 may be attached to the rear side of the substrate 10. The tape structure 30 may include an attachment part 25 attached to the substrate 10, and off-position parts 21 each spaced apart from the substrate 10 and having at least one ventilation hole 27. The attachment part 25 may have closed-loop shapes surrounding the off-position parts 21. The tape structure 30 may be made of a tape which includes a synthetic resin film 22a and an adhesive 22b applied to the bottom side of the synthetic resin film 22a. Auxiliary patterns 23 may be attached to the synthetic resin film 22a of the off-position parts 21 so as to space the off-position parts 21 apart from the substrate 10. If the substrate 10 is a thin-film structure substrate such as a satellite solar panel or antenna used in space industries, the synthetic resin film 22a and the auxiliary patterns 23 may be formed of polyamide films that is stable in a wide temperature range. In this case, the tape structure 30 may be formed by using a Kapton film including a polyamide film. If the substrate 10 is a thin-film structure substrate used at atmospheric pressure, the tape structure 30 may be formed by using a generally used tape. The same tape structures 30 may be repeatedly attached along a side of the substrate 10. The diameter of the ventilation holes 27 may be about 0.1 mm, and the distance (D) between the ventilation holes 27 may be constant, for example, about 10 mm Alternatively, the distance (D) may not be constant. Air layers 35 may be formed between the substrate 10 and the off-position parts 21, and air may freely flow outward from the insides of the air layers 35 through the ventilation holes 27. That is, the pressure of the air layers 35 may be equal or similar to the outside pressure.

When a satellite equipped with the acoustic load reducing structure 100 is launched, a lower acoustic load may be applied to the substrate 10 owing to the resilience of the synthetic resin film 22a of the attachment part 25 of the tape structure 30 and shock-absorbing ability of the off-position parts 21.

### Experimental Example

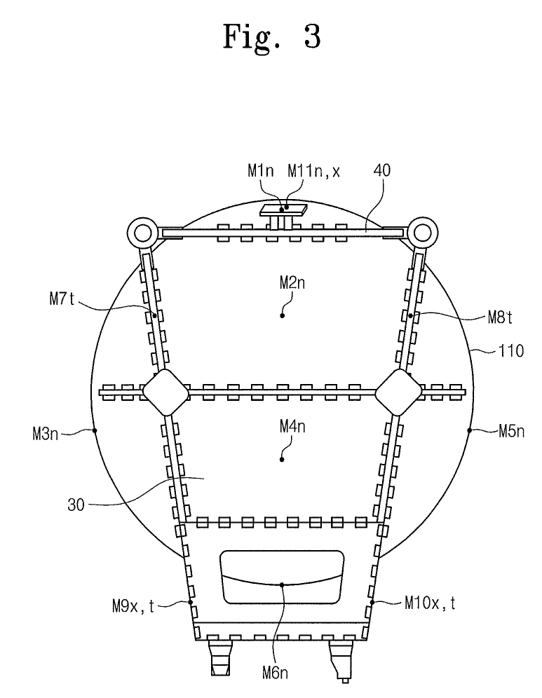

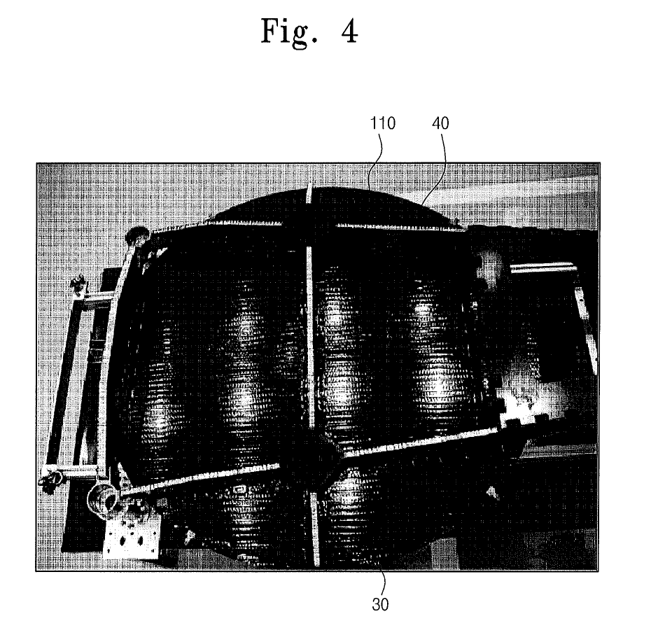

FIG. 3 is a view illustrating exemplary sensor arrangement on the acoustic load reducing structure in an experiment performed according to the present invention, and FIG. 4 is an image illustrating the acoustic load reducing structure in the experiment performed according to the present invention.

An experiment was performed to evaluate the effects of the acoustic load reducing structure of the present invention. First, as shown in FIG. 3, the rear side of a circular satellite antenna reflection plate 110 was fixed to a frame 40. Then, accelerometers M1n, M2n, M3n, M4n, M5n, M6n, M7t, M8t, M9x, M9t, M10x, M10t, M11n, and M11x were disposed at predetermined positions as shown in FIG. 3. An acoustic test was performed on the antenna reflection plate 110 in an acoustic chamber. Thereafter, the tape structure 30 illustrated in FIGS. 1 and 2 was attached to the rear side of the antenna reflection plate 110 as shown in FIG. 4, and an acoustic test was performed again on the antenna reflection plate 110. The test results are shown in Table 1. Values of Table 1 are root-mean-square (RMS) of measured acceleration values.

TABLE 1

RMS acceleration values (g-force)

| | Before attachment of | After attachment of |
|---|---|---|
| Accelerometers | tape structure | tape structure |
| M1n | 31.5 | 21.6 |
| M2n | 50.7 | 43.1 |
| M3n | 85.6 | 37.1 |
| M4n | 52.3 | 35.5 |
| M5n | 86.0 | 40.5 |
| M6n | 98.0 | 64.2 |
| M7t | 19.3 | 6.4 |
| M8t | 19.7 | 6.9 |
| M9x | 36.0 | 18.6 |
| M9t | 22.1 | 7.1 |
| M10x | 38.2 | 21.2 |
| M10t | 23.2 | 7.3 |
| M11n | 32.4 | 17.3 |
| M11x | 31.5 | 19.7 |

As shown in Table 1, the maximum acceleration value of 98.0 g was measured at the accelerometer M6n, and after the tape structures 30 was attached, the maximum acceleration was reduced to 64 g by about 35%. Acceleration values measured from the other positions were also reduced more than about 30% to about 50%. That is, acoustic loads could be considerably reduced by using the acoustic load reducing structure of the present invention.

Therefore, structures can be used under more extreme acoustic load conditions by using the acoustic load reducing structure of the present invention. In other words, lighter structures can be designed and manufactured without reducing the design safety factor. Thus, the efficiency of structures can be improved.

According to an embodiment of the present invention, the acoustic load reducing structure includes a tape structure. The tape structure includes an attachment part configured to be attached to a substrate, and an off-position part spaced apart from the substrate and having at least one ventilation hole. Therefore, owing to the resilience of the attachment part and shock-absorbing ability of an air layer formed between the off-position part and the substrate, an acoustic load can be reduced. In addition, since air can flow through the ventilation hole, the attachment part of the tape structure may be not separated by variations of air pressure.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

1. A structure for reducing an acoustic load, the structure comprising:
a substrate; and
a tape structure disposed at a side of the substrate,
wherein the tape structure comprises:
an attachment part configured to be attached to the substrate; and
an off-position part spaced apart from the substrate and comprising at least two ventilation holes.

2. The structure of claim 1, wherein the attachment part has a closed loop shape, and an air layer is formed between the off-position part and the substrate.

3. The structure of claim 1, wherein the tape structure comprises a Kapton tape.

4. The structure of claim 1, wherein the tape structure is repeatedly attached to the side of the substrate in the same pattern.

5. The structure of claim 1, wherein the substrate is a thin-film structure substrate.

6. The structure of claim 1, wherein the tape structure further comprises:
an synthetic resin film;
an adhesive applied to a bottom side of the synthetic resin film; and
an auxiliary pattern attached to a bottom side of the adhesive of the off-position part.

7. The structure of claim 1, wherein an entire region of the off-position part is continuously spaced apart from the substrate.

8. The structure of claim 1, wherein a distance between two adjacent ventilation holes of said off-position part is constant.

9. The structure of claim 1, wherein, taken from a plan view, said off-position part having at least two ventilation holes is rectangular.
